(19) United States
(12) Patent Application Publication
(10) Pub. No.: US 2015/0206374 A1
(43) Pub. Date: Jul. 23, 2015

(54) ADAPTABLE SOLID PRODUCT DISPENSER DISPLAY

(71) Applicant: Intercontinental Great Brands LLC, East Hanover, NJ (US)

(72) Inventors: Ricardo Rodriguez Sola, Buenos Aires (AR); Marcelo de Mello Paiva Caetano, Sao Paulo (BR); Daniel Taboada Dias da Silva, Sao Paulo (BR)

(21) Appl. No.: 14/420,793

(22) PCT Filed: Aug. 23, 2013
(86) PCT No.: PCT/US13/56330

§ 371 Date: Feb. 10, 2015

Related U.S. Application Data
(60) Provisional application No. 61/692,865, filed on Aug. 24, 2012.

(51) Int. Cl. G07F 11/52; G07F 11/40; G07F 11/00

(52) U.S. Cl. CPC G07F 11/52; G07F 11/007; G07F 11/40

(57) ABSTRACT

A dispenser for displaying and dispensing products including a support structure and a plurality of product dispensing trays. In one embodiment, the support structure includes a hollow cylindrical container mounted on a horizontal shaft linking to respective parallel planes that define a supporting base. The container is formed by a surrounding wall having a plurality of sections connected to the perimetrical edges of the container. Each section has a landscape rectangular portion for displaying and dispensing products from the greater edges of which arise flanges that fold distally, to an extent just greater than the thickness of one product, on incoming stops that hold frontally the first one of a plurality of products contained in successive contact on an inner tray mounted radially, stressed by a pusher actuated by springs to fall through the window until the backstop, the first product being positioned for removal in lateral displacement as a dovetail guide, so that the consumer may view all of the tastes offered by rotating the container with the fronts of the products visible and remove the one he prefers.

### CROSS REFERENCE TO RELATED APPLICATIONS

This application claims priority to U.S. Provisional Patent Application No. 61/692,865 filed on Aug. 24, 2012, the contents of which is incorporated herein by reference in its entirety.

### BACKGROUND OF THE INVENTION

The present invention relates generally to product displays, and more particularly to a solid product dispenser display designed for display and selective removal of products, wherein the display can be adapted to display products of different sizes and the display itself can be of different sizes.

Dispensing trays for displaying and dispensing products are well known in the art. Such trays typically have a backstop at their mouth, which allows for individual removal of products from among a plurality of units falling into their front. The products may be pushed by a spring or may be gravity fed down along the slope of its floor. Such trays are typically displayed on shelves or on supporting structures, in a number equivalent to the variety of tastes offered occupying a large front space.

It is also known in the art to display such trays in vertical stacks. However, in order to display many variants of products, the height of these stacks may become excessive and it also becomes difficult to access the higher layers. Also, reloading of trays in the middle of the stack is also cumbersome.

Other known types of product dispensers include vertical tubular enclosures with a removal window on their lower base. Removal of each unit from the window causes a subsequent product to drop into the window. Here too, however, in order to display a variety of products, a large number of displays are required, which are equivalent to the variety of tastes offered. The disadvantage with these product dispensers is the large amount of shelf space they occupy.

### SUMMARY OF THE INVENTION

Therefore, an object of the present invention is to provide a solid product dispenser display of a novel ornamental appearance, which, while occupying a reduced space, allows for consumer's interaction, and allows for the product to be easily removed. In one embodiment, a consumer interacts with the display by rotating a wide range of tastes displayed and stopping at a particular product that the consumer prefers.

Another object of the present invention is to provide a solid product dispenser display, which allows for easy reloading of the product tray with the variety depleted in a simple movement regardless of the remaining trays.

These and other objects are achieved with the adaptable solid product dispenser display of the present invention. The display of the present invention generally includes a support structure including a base for resting the display on a surface. The support structure supports a plurality of trays containing the solid product to be dispensed.

In a preferred embodiment, the support structure generally includes a hollow cylindrical container mounted onto a horizontal shaft of a base. The bases of the container may be discs. The base includes parallel planes that define a fork joined downwards to a support with a support base. The surrounding wall of the cylindrical container includes a plurality of sections astride the perimetrical edges of both discs. The sections are defined by circular washer sections that are fixed on their outer faces. Each of the sections have a landscape rectangular display and dispense portion, such as a window, bounded on its greater edges with flanges that extend outwardly from the window and are distally folded to form incoming stops. The flanges have a height just greater than the thickness of the product to be dispensed, and the incoming stops hold a first one of a plurality of products contained in successive contact on a radially mounted inner tray of the cylindrical container. The tray includes a spring-actuated pusher to push and lead the products through the window. The window and flange/incoming stop arrangement provides a dovetail guide, wherein the first product is positioned to be taken in lateral displacement. The device allows the consumer to view all of the different products offered by rotating the container with the fronts of the products visible and to take the one product preferred.

In a preferred embodiment, plates are provided that neatly cover the ends of the horizontal shaft and contain advertisements. The plates preferably overlap the outer planes of the fork.

Also, reloading of products can be done by disassembling the corresponding section from the wall surrounding the cylinder, removing the upper lid of the tray and retracting the pusher.

The solid product dispenser display of the present invention is also adaptable to display and self-dispense products of different sizes. In this case, the display includes a base, a shaft coupled to the base, a hollow cylindrical container including two discs mounted freely rotating about the shaft, a first set of a plurality of product dispensing cassettes mountable to the hollow cylindrical container around an entire circumference of the hollow cylindrical container and a second set of a plurality of product dispensing cassettes mountable to the hollow cylindrical container around the entire circumference of the hollow cylindrical container. Each cassette includes a face plate section and a tray for supporting products, wherein the face plate section has a window for displaying and dispensing the products and further defines an arc length. The arc lengths of the face plates of the first set of product dispensing cassettes is different than the arc lengths of the face plates of the second set of product dispensing cassettes, but all arc length are a multiple factor of the circumference of the hollow cylindrical container.

In an alternative embodiment, the support structure is generally a vertical frame for supporting a plurality of product dispensing trays in a vertical alignment, with one tray disposed on top of another. In this embodiment, two or more vertical frames can be assembled together to form a pad. Also, the vertical frame and/or the pad can be combined with the wheel embodiment of the product dispenser described above to form a completely versatile and adaptable display system.

The present invention further involves a method for displaying and dispensing products. The method generally includes the step of providing a single dispensing device including a base, a shaft coupled to the base and a hollow cylindrical container mounted freely rotating about the shaft. A first set of a plurality of product dispensing cassettes is mounted to the hollow cylindrical container of the device around an entire circumference of the hollow cylindrical container. When it is desired to display a differently sized product with the single device, the first set of the plurality of product dispensing cassettes is removed from the device and a second set of a plurality of product dispensing cassettes is mounted to the hollow cylindrical container of the device around the entire circumference of the hollow cylindrical container. Each cassette includes a face plate section and a tray for supporting products, wherein the face plate section has a portion for displaying and dispensing the products and further defines an arc length. The arc lengths of the face plates of the first set of product dispensing cassettes is different than the arc lengths of the face plates of the second set of product dispensing cassettes, but all arc length are a multiple factor of the circumference of the hollow cylindrical container.

In another embodiment, the present invention provides a solid product dispenser display combination for displaying and self-dispensing products. The combination includes a first dispensing device including a base, a shaft coupled to the base and a hollow cylindrical container including two discs mounted freely rotating about the shaft, wherein the discs define a first circumference. The combination further includes a second dispensing device including a base, a shaft coupled to the base and a hollow cylindrical container including two discs mounted freely rotating about the shaft, wherein the discs of the second device define a second circumference, which is different than the first circumference. A first number of product dispensing cassettes is mounted to the hollow cylindrical container of the first dispensing device around the entire first circumference of the two discs and a second number of product dispensing cassettes is mounted to the hollow cylindrical container of the second dispensing device around the entire second circumference of the two discs, wherein the second number of product dispensing cassettes is different than the first number of product dispensing cassettes. Each product dispensing cassette includes a face plate section and a tray for supporting products. Each face plate section has a portion for displaying and dispensing the products and each face plate section further defines an arc length, wherein both the first circumference of the two discs of the first dispensing device and the second circumference of the two discs of the second dispensing device are multiples of the arc length of the face plate.

The preferred embodiments of the device and method of the present invention, as well as other objects, features and advantages of this invention will be apparent from the following detailed description, which is to be read in conjunction with the accompanying drawings. The device is illustrated schematically and without any determined scale on the attached drawing sheets.

### BRIEF DESCRIPTION OF THE DRAWINGS

FIG. 1 is a perspective view of the solid product dispenser display according to a preferred embodiment of the present invention.

FIG. 2 is a side elevation view thereof.

FIG. 3 is front elevation view thereof.

FIG. 4 is an exploded perspective view of the tray and of the corresponding section of the surrounding face.

FIG. 5 is an elevation view of the inner face of one of the discs.

FIG. 6 is a side view of a tray set up with the surrounding face drawn as a cutout.

FIG. 7 is a perspective view of a first size cassette for use in the solid product dispenser display according to the present invention.

FIG. 8 is a partial cross-sectional view of the solid product dispenser display according to the present invention with the cassette shown in FIG. 7 installed therein.

FIG. 9 is a perspective view of a second size cassette for use in the solid product dispenser display according to the present invention.

FIG. 10 is a partial cross-sectional view of the solid product dispenser display according to the present invention with the cassette shown in FIG. 9 installed therein.

FIGS. 11a, 11b and 11c are side views of the solid product dispenser display according to the present invention provided in three different sizes.

FIG. 12 is a top perspective view of an alternative embodiment of the solid product dispenser display according to the present invention.

FIG. 13 is a side view of several product dispensing cassettes according to an alternative embodiment of the present invention.

FIG. 14 is a partial cross-sectional view of the solid product dispenser display shown in FIG. 12, with the cassettes shown in FIG. 13 installed.

FIG. 15 is a partial cross-sectional view of the solid product dispenser display shown in FIGS. 12 and 14 with an alternative embodiment of the cassette installed therein.

FIG. 16 is a rear perspective view of the cassette shown in FIGS. 13 and 15.

FIG. 17 is a top perspective view of a plurality of vertical frames assembled together to form a pad.

FIG. 18 is a top view of the pad shown in FIG. 17.

FIG. 19 is a top perspective view of two pads assembled together to form a display system.

FIG. 20 is a top view of the display system shown in FIG. 19.

FIG. 21 is a perspective view of a plurality of vertical frames and pads, as shown in FIGS. 12-17, combined together with the wheel dispenser embodiment, as shown in FIG. 1 to form another display system.

### DETAILED DESCRIPTION OF THE PREFERRED EMBODIMENTS

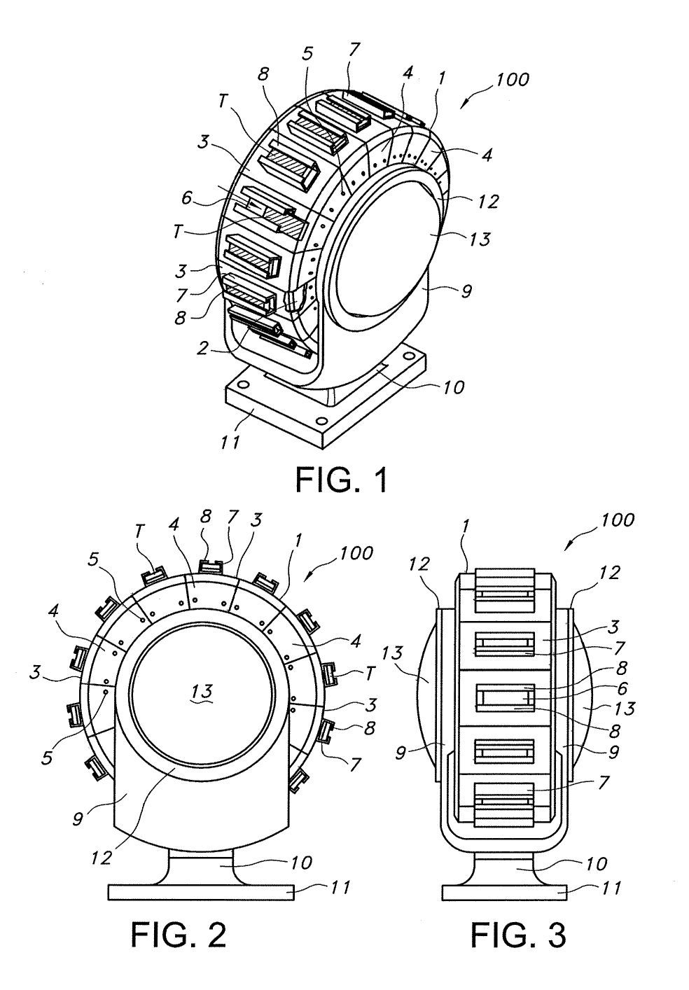

A preferred embodiment of the dispenser display of the present invention is shown in FIG. 1. In this embodiment, the dispenser display 100 of the present invention generally includes a support structure 1 in the form of a cylindrical container, mounted freely rotating about a horizontal shaft, and a base to support the container. In one preferred embodiment, the cylindrical container is defined by two parallel discs 2 as bases and a circumferential surrounding wall formed by a plurality of sections 3 that are mounted astride the perimetrical edges of the two parallel discs 2.

Each of the wall sections 3 have lateral folded over sections 4, which together form circular washer sections on respective outer surfaces of the two parallel discs 2. The lateral folded over sections 4 are preferably attached in position to the two parallel discs 2 by screws 5.

Each wall section 3 is further defined by a face disposed between the lateral folded over sections 4. The face is formed with a rectangular-shaped window 6, through which a product is displayed and dispensed, as will be discussed in further detail below. The window 6 is bounded on its opposite greater edges with flanges 7, which extend radially outwardly from the wall section face. These flanges 7 have a height that is just greater than the thickness of the product (T) and are distally folded inwardly toward one another to form incoming stops 8 that frontally hold the first one of a plurality of products T contained in successive contact on a radially mounted inner tray, which will be discussed in further detail below. On one of the sections of the surrounding wall of the container, the way of removing the product (T) by lateral sliding on the dovetail guide of the flanges 7, is illustrated.

The shaft, which rotatably supports the container 1, is linked to each of two parallel planes 9 that define a fork of the base. The fork is joined downwards to a support 10 with a supporting base and a setting 11. The parallel planes preferably include outer faces having circular projections 12 that frame convex plates 13 in order to show brands or advertisements.

FIG. 2 is a side view of the dispenser display showing the cylindrical container 1 mounted between the planes 9 of the fork with the support 10 joined to the base 11. FIG. 2 further shows the sections 3 with their circular washer sections 4 fixed to the rotating discs 2 by the screws 5. As can be further seen in FIG. 2, the flanges 7 with the backstops 8 define the dovetail guides in order to hold a product T shown waiting and the advertising plates 13 are framed by circular projections 12. With similar references, the front view of FIG. 3 shows the same outer components of the preceding figures.

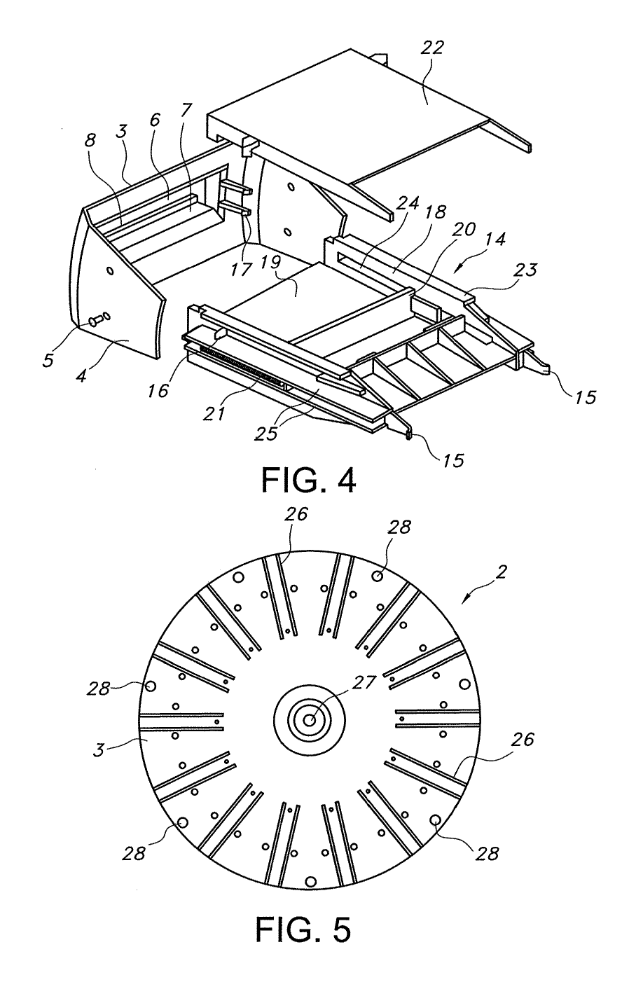

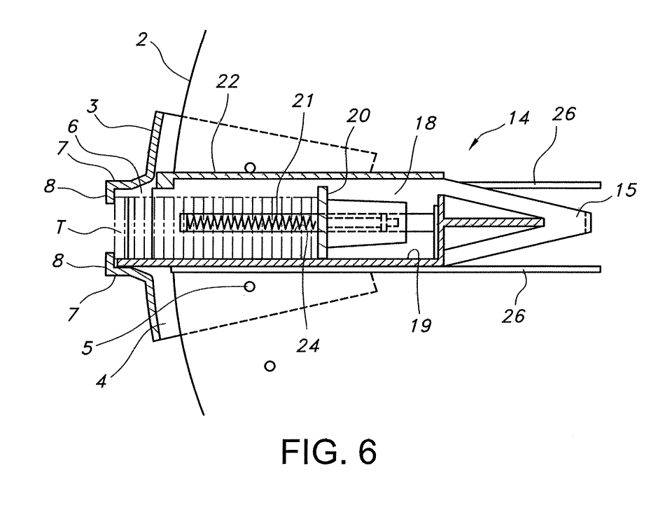

FIG. 4 illustrates an exploded perspective view of a supplying tray 14 with anchoring means 15 for anchoring the tray 14 to the discs 2 at its back end. The tray 14 is further provided with appendices 16 for anchoring the front end of the tray 14 to the corresponding section of the surrounding wall 3 by elastic tabs 17. The tray 14 has two side walls 18 that, together with a floor 19, define a space where the products are loaded to be displaced towards the window 6 of the surrounding section 3. The products are urged toward the window 6 by a pusher 20 movably disposed in the space of the tray. The pusher 20 is preferably biased by the stress from at least one spring 21. The space is closed by an upper lid 22 of the sliding wedge, which is attached to side flanges 23 of the side walls 18 of the tray.

The side walls 18 of the tray 14 are preferably formed with longitudinal grooves 24, which receive and guide the ride of appendices formed on the pusher 20. The grooves 24 also link the pusher to the tension springs 21, which may be housed between pairs of outer longitudinal flanges 25 formed on the outside surface of the tray side walls 18.

In FIG. 5, the inner face of one of the discs 2 is illustrated in order to show a plurality of radial pairs of projections 26 designed to each support a tray 14, wherein the tray 14 fits between side flanges of the projections 26. As also shown in FIG. 5, each disc 2 is formed with a shaft mounting hub 27 and a plurality of spacer pins 28. The shaft mounting hub 27 receives the shaft of the device in a manner to allow free rotation of the container, while the spacer pins 28 provide structural support between the opposite discs 2.

FIG. 6 shows a cross-section along a central vertical plane of a portion of the container 1, where the perimetrical edge of each of the discs 2 with a tray 14 set on its corresponding pair of radial projections 26 can be seen. The tray 14 is anchored by its rear elastic lock 15, and is closed at the top by the lid. The tray 14 is further frontally assembled to the corresponding section 3 of the surrounding wall. As can also be seen in FIG. 6, the folded over side section 4 is fixed to the disc 2 by the screws 5.

A row of products (T) (drawn in dash-dot lines) is received in the floor 19 of the tray 14 and is pushed by the pusher 20, due to the urging of the spring 21, toward the backstops 8 of the flanges 7 that arise from the upper and lower edges of the window 6. The first product has its front visible and ready for its side removal. Depending on the size and format of the product, it is also within the scope of the invention for the product to be removed from the front of the window 6, as opposed to lateral removal.

When it is necessary to reload products (T), the entire tray 14 can be removed from the wheel 2, by unfastening the screws 5 and loading additional products onto the tray floor 19 between the tray side walls 18. Alternatively, the tray 14 can be left attached to the wheel 2 and additional products (T) can be frontally loaded through the window 6 against the biasing action of the pusher 20.

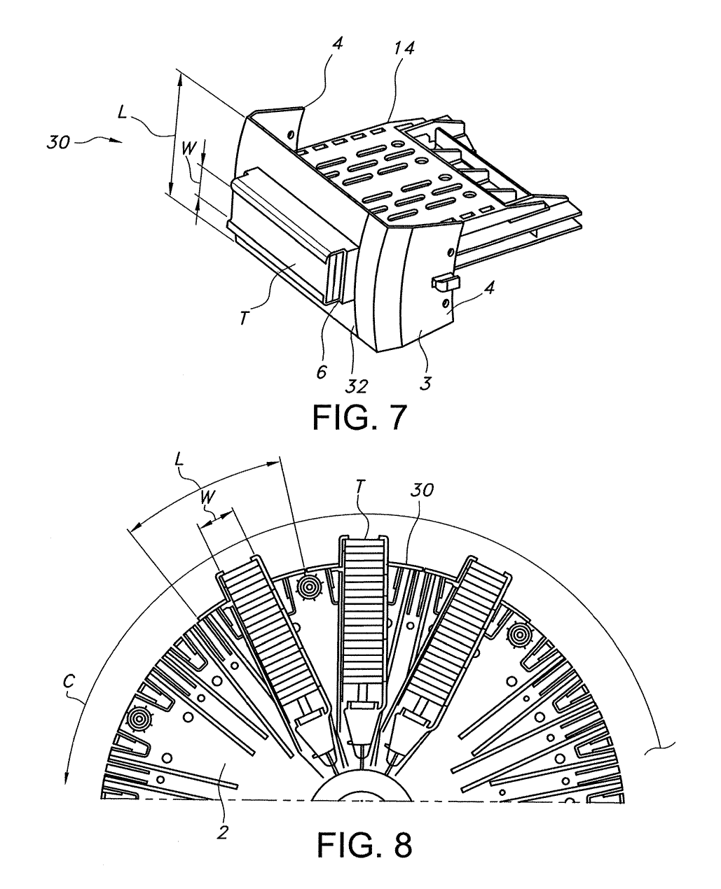

The solid product dispenser display of the present invention is adaptable to accommodate products of different sizes and is also adaptable to accommodate the same sized product with differently sized wheels. For example, FIGS. 7 and 8 show a cassette 30 containing a product T having a width W. The cassette 30 is similar to that described above in that it includes a tray 14 and a wall section 3, wherein the wall section is formed by a face plate 32 having a window 6 and a pair of lateral folded over sections 4. In this case, the wall section 3 has an arc length L sufficient to accommodate the product T having a width W within the window 6. The arc length L is also chosen to be a multiple factor of the circumference C of the wheel 2 so that a whole number of cassettes are provided around the wheel. For example, if the wheel 2 has a circumference of 600 mm and the product T has a width of 30 mm, the arc length L of the wall section 3 can be conveniently chosen to be 60 mm so that 10 cassettes can be uniformly distributed around the wheel.

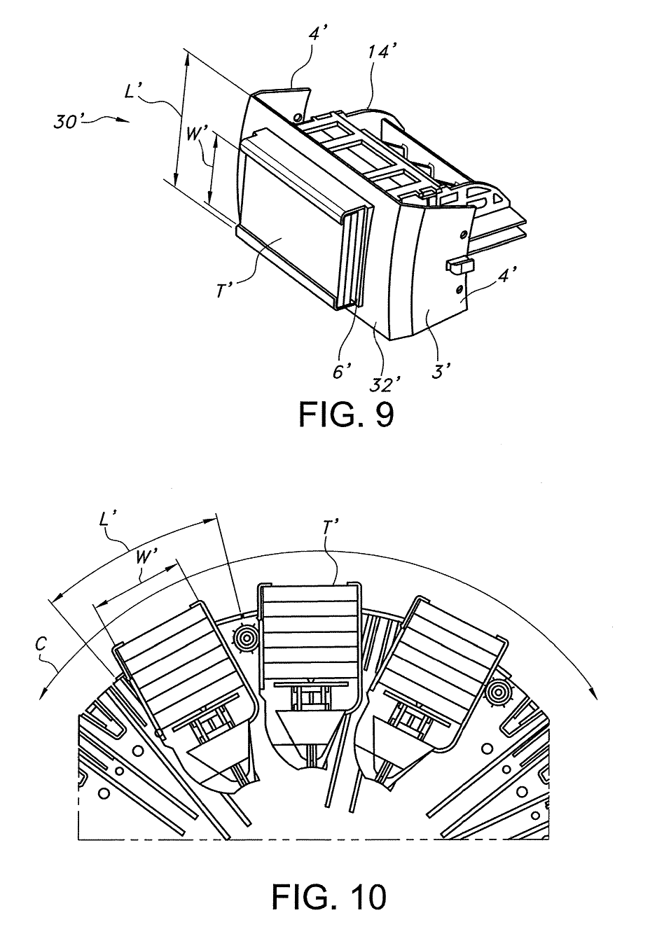

If, on the other hand, a product T′ having a width W′ of 45 mm, for example, is to be displayed and dispended from the device of the present invention, a larger size cassette 30′ will be necessary, as shown in FIGS. 9 and 10. The larger cassette 30′ is again similar to that described above in that it includes a tray 14′ and a wall section 3′, wherein the wall section is formed by a face plate 32′ having a window 6′ and a pair of lateral folded over sections 4′. However, in this case, the wall section 3′ has an arc length L′ sufficient to accommodate the product T′ having a 45 mm width W′ within the window 6′. Here too, the arc length L′ is also chosen to be a multiple factor of the circumference C of the wheel 2 so that a whole number of cassettes are provided around the wheel. Thus, in the example given above, where the wheel 2 has a circumference of 600 mm, the arc length L′ of the wall section 3′ can be conveniently chosen to be 75 mm so that 8 cassettes can be uniformly distributed around the wheel.

It can be appreciated that a multitude of cassette sizes can be utilized with the same size wheel. As a result, a standard wheel could use cassettes of different sizes so that the same wheel can be used to display and dispense a product different from the product on an identical wheel. Thus, while the wheel will preferably dispense only a single type of product, the same wheel can be used in each instance. In this improvement, the face clip 3 of the cassette 30, i.e., the portion that makes the outer circumference of the cassette changes for each different type of product. Since the face clip of the cassette differs for each type of product, while the wheel remains the same, the number of cassettes is going to change based on the arc length of the face clip for each product.

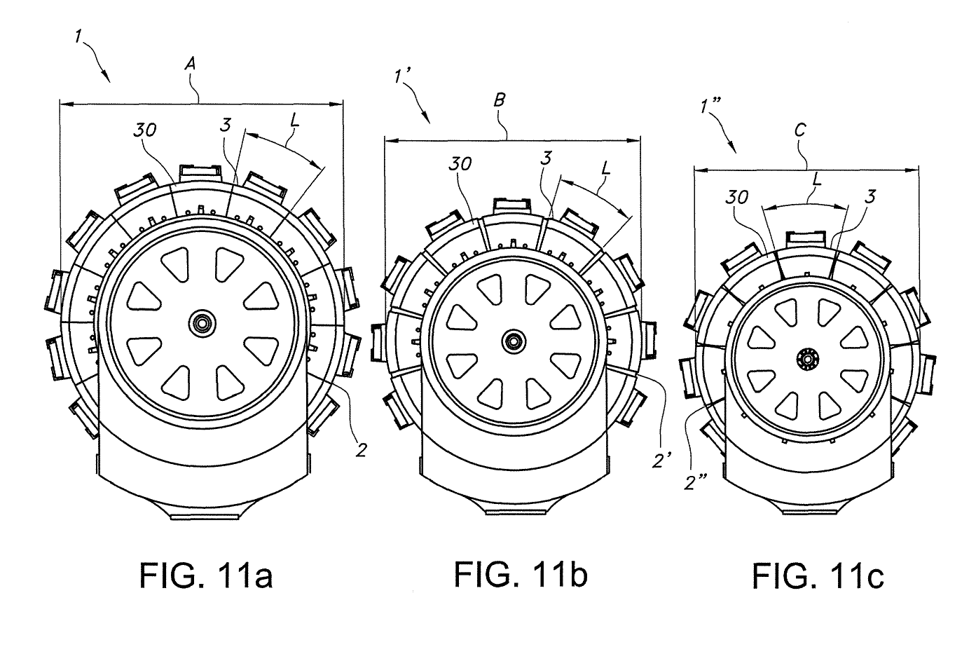

FIGS. 11a, 11b and 11c show another feature relating to the adaptability of the solid product dispenser display 1, 1′, 1″ according to the present invention. In this embodiment, the same product cassette 30 can be used in different diameter wheels 2, 2′, 2″. This is in situations where space is at a premium and small wheels are desired. It is noted that the arc length L of the face clip 3 is identical so that when the diameter A, B, C of the wheel 2, 2′, 2″ is reduced, there will be a reduction in the number of cassettes 30, which span the circumference.

To achieve this, the diameter A, B, C of each wheel is chosen to result in a circumference of the wheel which is a multiple of the arc length L of the face plate 3 of the cassette 30. For example, if a cassette 30 having a face plate 3 with an arc length of 60 mm is used, a wheel 2 having a circumference of 840 mm will accommodate 14 cassettes, as shown in FIG. 11a. The diameter A of such a wheel will be about 268 mm.

If a smaller wheel 2′ is desired, the circumference is reduced to a number that is still a multiple of the arc length L of the cassette 30. Thus, for example, a wheel 2′ having a circumference of 720 mm will accommodate 12 cassettes 30, as shown in FIG. 11b. The diameter B of such a wheel will be about 229 mm.

If still a smaller wheel 2″ is desired, the circumference can be reduced again to a number that is a multiple of the 60 mm arc length L of the cassette 30. Thus, for example, a wheel 2″ having a circumference of 600 mm will accommodate 10 cassettes 30, as shown in FIG. 11c. The diameter C of such a wheel will be about 191 mm.

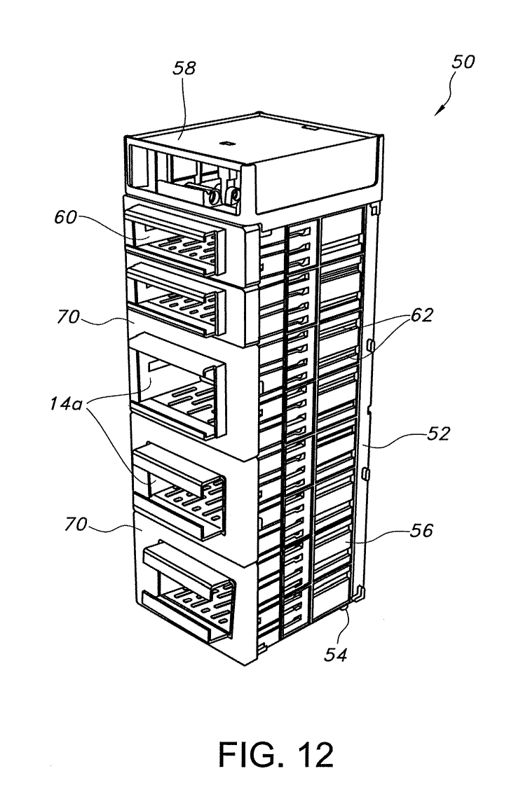

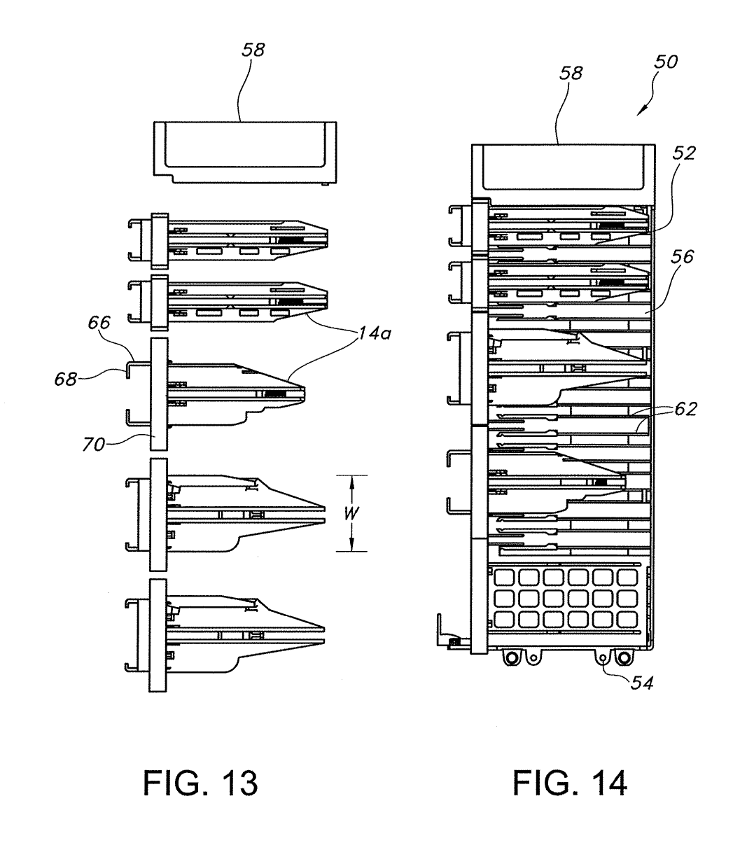

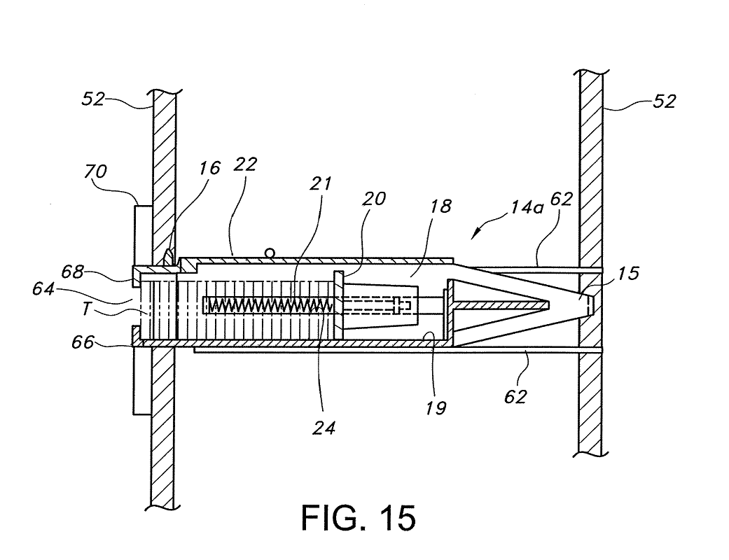

FIGS. 12-14 show an alternative embodiment of the dispenser display of the present invention. In this embodiment, the dispenser display 50 of the present invention generally includes a support structure 52 in the form of a vertical frame. As described in the embodiments above, the vertical frame 52 includes a base 54 for resting the frame on a surface. In this case, however, the frame 52 is further defined by two lateral side walls 56 extending upwardly from opposite ends of the base 54. A top 58 connects the upper ends of the lateral side walls 56 opposite the base 54. In this manner, the frame 52 defines a front opening 60 for loading a plurality of product trays 14a in a vertical alignment, as will be described in further detail below.

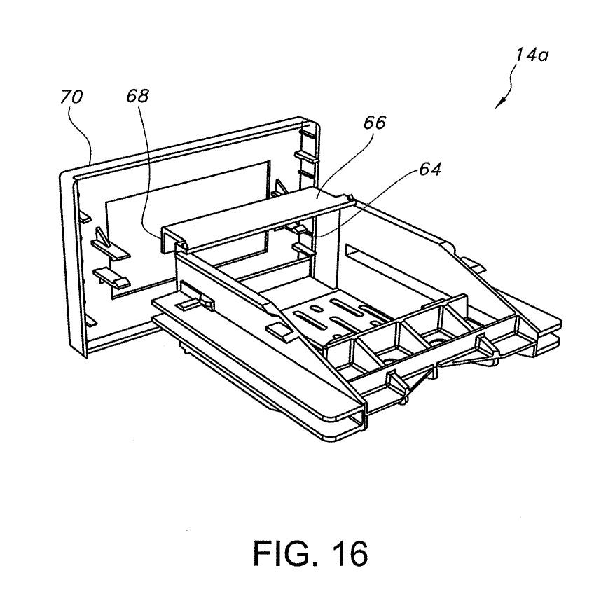

The vertical frame 52 is adapted to support a variety of sizes of product dispensing trays, as described above, in a vertical alignment, as opposed to the radial arrangement described above. Referring additionally to FIGS. 15 and 16, the supplying tray 14a has anchoring means 15, as described above, for anchoring the tray 14a to the back end of each lateral wall 56 of the vertical frame 52. The tray 14a is further provided with appendices 16 for anchoring the front end of the tray 14a to the corresponding section of the lateral wall 56.

Essentially all of the components of the tray 14a shown in FIGS. 15 and 16 are the same as that described above and shown in FIGS. 4 and 6. Thus, the tray 14a has two side walls 18 that, together with a floor 19, define a space where the products are loaded to be displaced towards the front opening 60 of the vertical frame 52. The products are urged forward by a pusher 20 movably disposed in the space of the tray. The pusher 20 is preferably biased by the stress from at least one spring 21. The space is closed by an upper lid 22 of the sliding wedge, which is attached to side flanges 23 of the side walls 18 of the tray.

The side walls 18 of the tray 14a are preferably formed with longitudinal grooves 24, which receive and guide the ride of appendices formed on the pusher 20. The grooves 24 also link the pusher to the tension springs 21, which may be housed between pairs of outer longitudinal flanges 25 formed on the outside surface of the tray side walls 18.

In this embodiment, each of the opposite inner surfaces of the vertical frame lateral side walls 56 include a plurality of horizontal pairs of projections 62 designed to each support a tray 14, wherein the tray 14 fits between side flanges of the projections 62. FIG. 15 shows a cross-section along a central vertical plane of a portion of the vertical frame 52, where a tray 14a set on its corresponding pair of projections 62 can be seen. The tray 14a is anchored by its rear elastic lock 15, and is closed at the top by the lid. The tray 14a is further frontally assembled to the corresponding section of the lateral wall 56 by the appendices 16.

However, FIGS. 15 and 16 show an alternative embodiment of a tray 14a, wherein the flanges and backstops, described above as being art of a separate wall section, are formed integrally with the tray body. Specifically, each tray body defines a rectangular-shaped window 64, through which a product is displayed and dispensed. The window 64 is bounded on its opposite greater edges with flanges 66, which extend outwardly from the front opening 60 of the vertical frame 52. These flanges 66 have a height that is just greater than the thickness of the product (T) and are distally folded inwardly toward one another to form incoming stops 68 that frontally hold the first one of a plurality of products T contained in successive contact on a horizontally mounted inner tray. As described above, removal of the product (T) is achieved by lateral sliding on the dovetail guide of the flanges 66. The flanges 66 with the backstops 68 define the dovetail guides in order to hold a product T shown waiting.

Once all of the trays 14a are loaded into the vertical frame 52, a plurality of appropriately sized face plates 70 can be used to close the front opening 60, as shown in FIG. 12-16. The face plates 70 are preferably thin rectangular plates defining a window for receiving the front end of a tray 14a. In this regard, the window and the height of the plate are chosen to match the dimensions of a respective tray 14a. The face plates 70 can be fastened to the lateral walls 56 of the vertical frame 52 by any conventional means. For example, cooperating detent structure between the face plate and the lateral walls can be provided so that the face plate can be snap-fit to the vertical frame. When it is necessary to reload products (T), the face plates 70 can be unfastened and the entire tray 14a can be removed from the vertical frame 52 by disengaging the anchors 15 and the appendices 16 from the lateral side walls 54.

The solid product dispenser display 50 of this embodiment is also adaptable to accommodate products of different sizes. For example, FIGS. 12-14 show tray and faceplate combinations for product T having varying widths W, wherein the width of the tray 14a and/or faceplate 70 is a multiple of the spacing between the projections 62 formed in the vertical frame 52. In this manner, the frame 52 can accommodate various sizes of trays 14a in a vertical alignment.

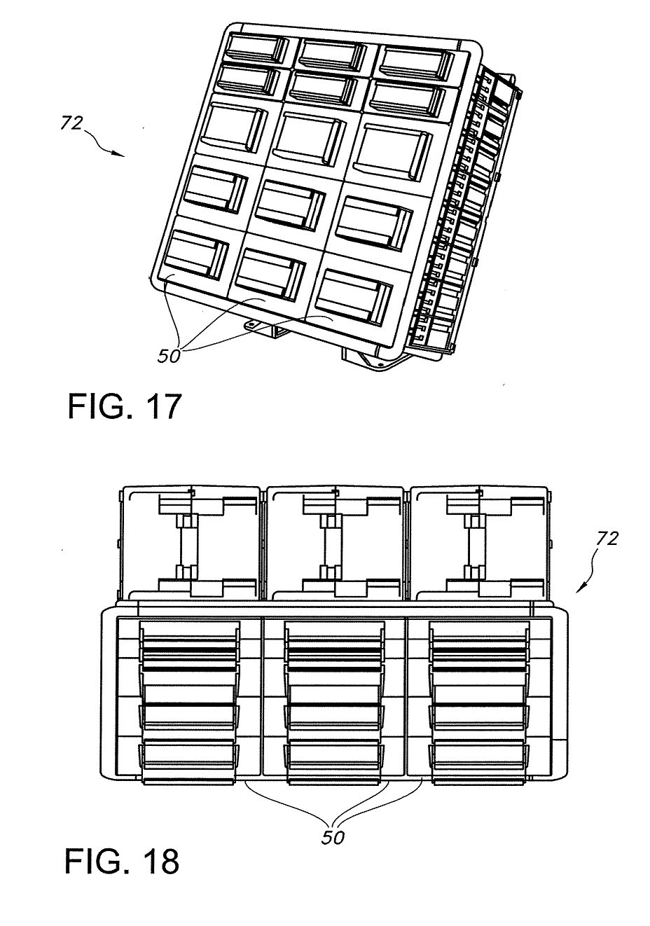

The solid product dispenser display 50 of this embodiment can also be assembled side-to-side with other vertical displays to form a pad 72, as shown in FIGS. 17 and 18. In this case, two or more vertical frames can be fastened together by conventional means to form a pad display having multiple vertical columns of trays.

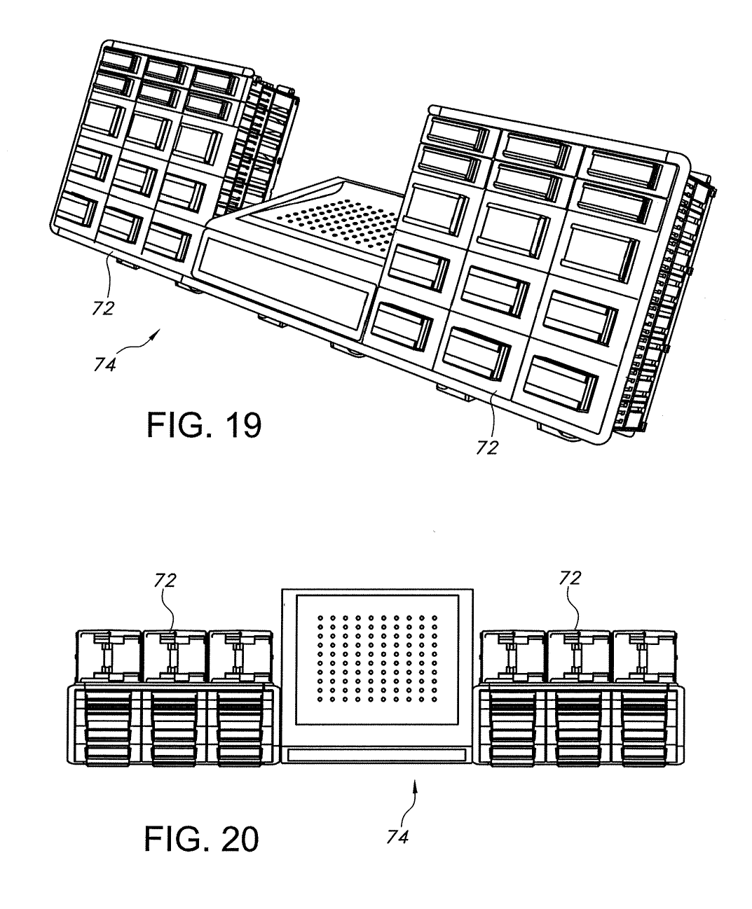

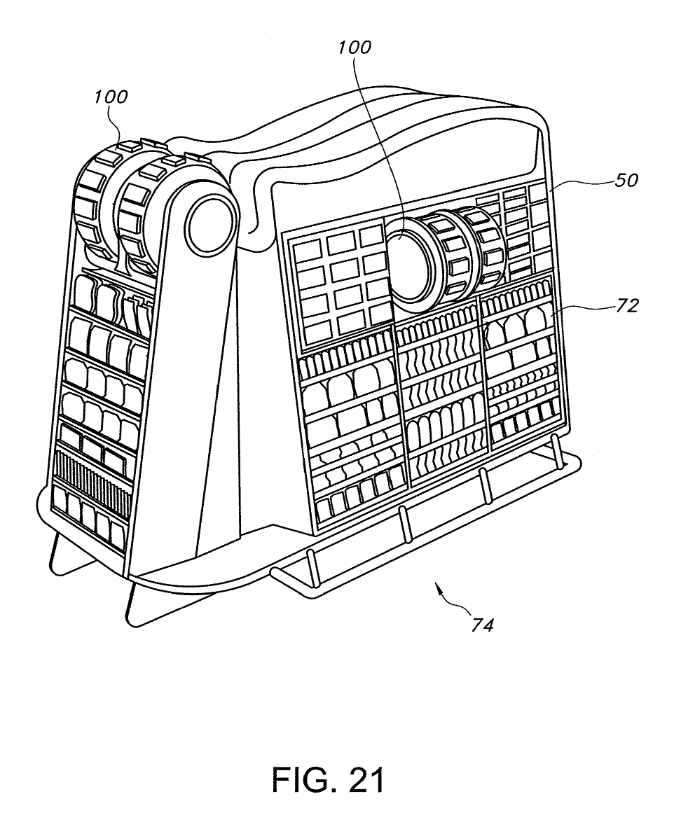

Furthermore, one or more pads 72 and/or one or more vertical displays 50 can be combined together and/or can be combined with one or more wheel displays 100, as described above to form a fully versatile display system 74, as shown in FIGS. 19-21. Again, the vertical frames, pads and wheels can be assembled together by any conventional manner.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A product dispenser display for displaying and self-dispensing products comprising:
a support structure defining an opening having a maximum dimension; and
a plurality of sets of product dispensing cassettes mountable within the opening of the support structure, each cassette including a face plate section and a tray for supporting products, each face plate section having a portion for displaying and dispensing the products and further defining a length, the length being a multiple factor of the maximum dimension of the opening of the support structure,
wherein the lengths of the face plate are the same within a set of product dispensing cassettes, but are different from one set to another such that the support structure can accommodate each of the plurality of sets.

2. The product dispenser display defined in claim 1, wherein said portion for displaying and dispensing said product defines a window.

3. The product dispenser display defined in claim 3, wherein each face plate section comprises flanges extending outwardly from greater edges of the window, the flanges having a height just greater than the thickness of one product and folding distally to form incoming backstops.

4. The product dispenser display defined in claim 1, wherein the support structure comprises:
a base;
a shaft coupled to the base; and
a hollow cylindrical container mounted freely rotating about the shaft, the hollow cylindrical container defining said opening,
wherein said plurality of sets of product dispensing cassettes are mountable to the hollow cylindrical container around an entire circumference of the hollow cylindrical container, and
wherein the length of each of said face plate sections defines an arc length, the arc length being a multiple factor of the circumference of the hollow cylindrical container.

5. The product dispenser display defined in claim 4, wherein said cylindrical container includes two discs.

6. The product dispenser display defined in claim 5, wherein the two discs of the hollow cylindrical container comprise inner faces having a plurality of radial pairs of projections, and wherein the cassettes of each of the first and second sets of the plurality of product dispensing cassettes are removably anchored on the radial pairs of projections.

7. The product dispenser display defined in claim 6, wherein each tray of the first and second sets of the plurality of product dispensing cassettes comprises a floor, side walls disposed on opposite ends of the floor to define a housing for receiving the products, and a transversal pushing partition movable within the housing for pushing products toward the window of each faceplate.

8. The product dispenser display defined in claim 6, wherein each tray of the first and second sets of the plurality of product dispensing cassettes further comprises at least one spring for urging the transversal pushing partition toward the window of each faceplate and a removable lid enclosing the housing.

9. The product dispenser display defined in claim 1, wherein the support structure comprises a vertical frame defining a base and two lateral side walls extending upwardly from opposite ends of the base.

10. A method for displaying and dispensing products comprising the steps of:
providing a single dispensing device including a base, a shaft coupled to the base and a hollow cylindrical container mounted freely rotating about the shaft;
mounting a first set of a plurality of product dispensing cassettes to the hollow cylindrical container of the device around an entire circumference of the hollow cylindrical container, each cassette including a face plate section and a tray for supporting products, each face plate section having a portion for displaying and dispensing the products and further defining a first arc length, the first arc length being a multiple factor of the circumference of the hollow cylindrical container;
removing the first set of the plurality of product dispensing cassettes from the device; and
mounting a second set of a plurality of product dispensing cassettes to the hollow cylindrical container of the device around the entire circumference of the hollow cylindrical container, each cassette including a face plate section and a tray for supporting products, each face plate section having a portion for displaying and dispensing the products and further defining a second arc length, the second arc length being different than the first arc length and also being a multiple factor of the circumference of the hollow cylindrical container.

11. A method of claim 10, wherein said container is defined by two parallel discs and a circumferentially surrounding wall.

12. A method of claim 11, wherein each of said mounting steps includes anchoring said cassettes to said discs.

13. A method of claim 10, wherein the number of first set of said plurality of product dispensing cassettes is different from the number of said second set of plurality of parallel dispensing cassettes.

14. A product dispenser display combination for displaying and self-dispensing products, the combination comprising:
a first dispensing device including a base, a shaft coupled to the base and a hollow cylindrical container including two discs mounted freely rotating about the shaft, the discs defining a first circumference;
a second dispensing device including a base, a shaft coupled to the base and a hollow cylindrical container including two discs mounted freely rotating about the shaft, the discs of the second device defining a second circumference, the second circumference being different than the first circumference;
a plurality of product dispensing cassettes mountable to the circumference of the hollow cylindrical container of the first and second dispensing devices,
wherein each product dispensing cassette includes a face plate section and a tray for supporting products, each face plate section having a portion for displaying and dispensing the products and further defining an arc length, wherein both the first circumference of the two discs of the first dispensing device and the second circumference of the two discs of the second dispensing device are multiples of the arc length of the face plate such that the first dispensing device accommodates a first number of product cassettes and the second dispensing device accommodates a second number of dispensing devices, the first number being less than the second number.

15. A product dispenser display combination of claim 14, wherein said portion for display and dispensing said product defines a window.

16. A product dispenser display combination of claim 15, wherein each tray of product dispensing cassettes comprises a floor, side walls disposed on opposite ends of the floor to define a housing for receiving the products, and a transversal pushing partition movable within the housing for pushing products toward the window of each faceplate.

17. A product dispenser display combination of claim 16, wherein each tray of product dispensing cassettes further comprises at least one spring for urging the transversal pushing partition toward the window of each faceplate and a removable lid enclosing the housing.
